(19) United States
(12) Patent Application Publication
(10) Pub. No.: US 2011/0158053 A1
(43) Pub. Date: Jun. 30, 2011

(54) Chronograph timepiece

(76) Inventors: Kenji Ogasawara, Chiba-shi (JP); Akira Takakura, Chiba-shi (JP); Saburo Manaka, Chiba-shi (JP); Keishi Honmura, Chiba-shi (JP); Takanori Hasegawa, Chiba-shi (JP); Kosuke Yamamoto, Chiba-shi (JP); Kazumi Sakumoto, Chiba-shi (JP); Hiroshi Shimizu, Chiba-shi (JP); Kazuo Kato, Chiba-shi (JP); Erico Noguchi, Chiba-shi (JP); Tomohiro Ihashi, Chiba-shi (JP)

(21) Appl. No.: 12/928,572

(22) Filed: Dec. 14, 2010

(30) Foreign Application Priority Data
Dec. 24, 2009 (JP) 2009-293023

(51) Int. Cl. G04F 8/00; G04B 19/04

(52) U.S. Cl. 368/80

(57) ABSTRACT

Provided is a chronograph timepiece to perform a system reset by an easy-to-understand operation for users, including a crown, an operating unit that at least starts and resets a time period measurement, a time hand drive unit that keeps time of day based on a clock signal for electrically driving a time hand so as to indicate the timed time of day, a chronograph hand drive unit that measures a time period based on a chronograph signal in response to the start for electrically driving a chronograph hand so as to indicate a measured time period and to reset the time period measurement in response to the reset directed by the operating unit, and a control unit that resets the time hand drive unit in response to a reset directed by the crown and resets the chronograph hand drive unit in response to the reset directed by the operating unit.

### BACKGROUND OF THE INVENTION

1. Field of the Invention

The present invention relates to a chronograph timepiece having functions of indicating time of day and measuring a time period.

2. Description of the Related Art

Conventionally, such chronograph timepieces have been developed that have functions of indicating time of day and measuring a time period, in which chronograph hands indicating a measured time period are electrically driven by motors and the chronograph hands are mechanically reset to zero using mechanical devices.

In the conventional chronograph timepieces, a system reset is performed for resetting a chronograph timepiece to its initial state to return the timepiece to the normal state after a battery used for a power supply is replaced, or when an integrated circuit (IC) is malfunctioned due to static electricity or the like.

System resets are performed in such a way that the back cover of a chronograph timepiece is opened and a system reset terminal is set at a predetermined voltage, or that a plurality of operation buttons provided for a chronograph timepiece are operated in combinations. On this account, system reset operations are difficult or become complicated (for example, see JP-A-2008-241329). Consequently, there is a problem in that it is difficult or complicated for ordinary users to perform a system reset for returning a chronograph timepiece to the normal state.

### SUMMARY OF THE INVENTION

It is an aspect of the present invention to allow system resets through an easy-to-understand operation for users.

According to the invention, provided is a chronograph timepiece including: a signal generating unit configured to output a clock signal to be reference for timing and a chronograph signal to be reference for measuring a time period; a crown; an operating unit configured at least to start and reset a time period measurement operation; a time hand drive unit configured to keep time of day based on the clock signal for electrically driving a time hand so as to indicate a timed time of day; and a chronograph hand drive unit configured to perform the time period measurement operation based on the chronograph signal in response to the start directed by the operating unit for electrically driving a chronograph hand so as to indicate a measured time period and to reset the time period measurement operation response to the reset directed by the operating unit, the chronograph hand being mechanically reset to zero in response to the reset directed by the operating unit. In the chronograph timepiece, a control unit is provided for resetting the time hand drive unit in response to a reset directed by the crown and resetting the chronograph hand drive unit in response to a reset directed by the operating unit.

According to the chronograph timepiece of the invention, for chronograph timepieces that chronograph hands are mechanically reset to zero and electrically driven, because electrical resets can be performed by means of typical operations for chronograph timepieces, components can be readily returned to normal operations since system resets can be performed by means of an easy-to-understand operation for users.

### BRIEF DESCRIPTION OF THE DRAWINGS

FIG. 1 shows a block diagram depicting a chronograph timepiece according to an embodiment of the invention;

FIG. 2 shows a detailed circuit diagram partially depicting the chronograph timepiece according to the embodiment of the invention; and

FIG. 3 shows a flow chart depicting the chronograph timepiece according to the embodiment of the invention:

### DETAILED DESCRIPTION OF THE INVENTION

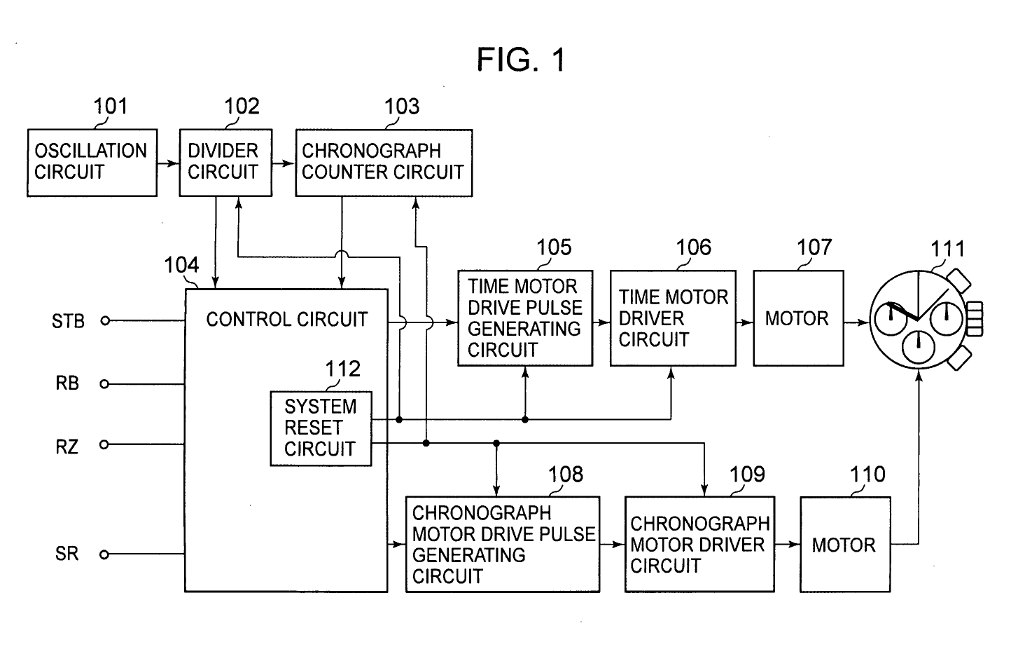

FIG. 1 is a block diagram depicting a chronograph timepiece according to an embodiment of the invention. The chronograph timepiece according to this embodiment is such a type of chronograph timepiece that chronograph hands are mechanically reset to zero and electrically driven.

In FIG. 1, the chronograph timepiece includes an oscillation circuit 101 that generates a signal at a predetermined frequency, a divider circuit 102 that has a plurality of dividing stages for dividing the signal generated by the oscillation circuit 101 to output a clock signal to be reference for timing operations to a control circuit 104 as well as to output a chronograph signal to be reference for time period measurement (chronograph) operations to a chronograph counter circuit 103, the chronograph counter circuit 103 that counts the chronograph signals to perform time period measurement operations, and the control circuit 104 that performs a variety of control including control over a timing function based on the clock signal, control over individual electronic circuit components configuring the chronograph timepiece, and drive control based on drive pulses.

Further, the chronograph timepiece includes a time motor drive pulse generating circuit 105 that generates a time motor drive pulse for driving the time hands of an analog indicating unit 111 in response to a time control signal from the control circuit 104, a time motor driver circuit 106 that drives a time motor 107 for driving the time hands in response to the time motor drive pulse from the time motor drive pulse generating circuit 105, and the time motor 107.

Furthermore, the chronograph timepiece includes a chronograph motor drive pulse generating circuit 108 that generates a chronograph motor drive pulse for driving the chronograph hands of the analog indicating unit 111 in response to a chronograph control signal from the control circuit 104, a chronograph motor driver circuit 109 that drives a chronograph motor 110 for driving the chronograph hands in response to the chronograph motor drive pulse from the chronograph motor drive pulse generating circuit 108, and the chronograph motor 110.

In addition, the chronograph timepiece includes the analog indicating unit 111 for indicating the timed time of day and a measured time period in an analog manner. The analog indicating unit 111 includes the time hands for indicating the current time of day in an analog manner and the chronograph hands for indicating a measured time period in an analog manner.

The control circuit 104 is connected with a start/stop button STB for directing the start and stop of time period measurement operations, a reset button RB for resetting time period measurement operations, a crown RZ for setting time and for performing reset operations, described later, or the like, and a system reset terminal SR for performing the system reset of the entire chronograph timepiece.

The start/stop button STB is operated to direct a start operation when a time period measurement operation is not performed, whereas the start/stop button STB is operated to direct a stop operation when a time period measurement operation is being performed. Also, the reset button RB is operated to direct a reset operation.

The control circuit 104 has a system reset circuit 112 therein for: (i) resetting all the circuits configuring the chronograph timepiece (system reset); (ii) performing a system reset (partial system reset) to only reset the individual circuits (time hand drive unit) for keeping time of day and driving the time hands (for example, an hour hand, minute hand, and second hand) of the analog indicating unit 111; and (iii) performing a system reset (partial system reset) to reset the individual circuits (chronograph hand drive unit) for measuring a time period and driving the chronograph hands (for example, a chronograph hour hand, chronograph minute hand, and chronograph second hand) of the analog indicating unit 111.

The control circuit 104 has functions of controlling the individual electronic circuit components by: (i) starting a time period measurement operation in response to a start directed by the start/stop button STB to show a measured time period on the analog indicating unit 111; (ii) stopping a time period measurement operation in response to a stop directed by the start/stop button STB; (iii) resetting a time period measurement counter (not shown) provided for the control circuit 104 in response to a reset directed by the reset button RB; and (iv) stopping a time period measurement operation due to the stopped chronograph motor 110. Further, the control circuit 104 also has a function of resetting a timing counter (not shown) provided for the control circuit 104 in response to a reset directed by the crown RZ.

Furthermore, the control circuit 104 has functions of: (i) keeping time of day based on the clock signal from the divider circuit 102 to output the time control signal at predetermined time in the motor drive cycle; and (ii) outputting a chronograph control signal for driving the chronograph motor 110 to the chronograph motor drive pulse generating circuit 108 every time when the chronograph counter circuit 103 keeps time for a predetermined time period (a drive cycle for the chronograph motor 110).

The time motor 107 and the chronograph motor 110 are stepping motors for use in typical electronic clocks. These stepping motors are such a type that includes a stator having a rotor accommodating through hole therein, a rotor rotatably disposed at the rotor accommodating through hole, and a drive coil wound on a magnetic core joined to the stator, in which drive pulses having different polarities are alternately supplied to a first terminal and a second terminal of the drive coil for rotating and driving the stepping motor at each predetermined angle.

Here, the oscillation circuit 101 and the divider circuit 102 constitute a signal generating unit. The start/stop button STB and the reset button RB constitute an operating unit. The timing counter of the control circuit 104, the time motor drive pulse generating circuit 105, the time motor driver circuit 106, and the time motor 107 constitute a time hand drive unit. The chronograph counter circuit 103, the time period measurement counter of the control circuit 104, the chronograph motor drive pulse generating circuit 108, the chronograph motor driver circuit 109, and the chronograph motor 110 constitute a chronograph hand drive unit. The rest of the control circuit 104 except the timing counter and the time period measurement counter constitute a control unit. The timing counter of the control circuit 104 constitute a timing unit, and the chronograph counter circuit 103 and the time period measurement counter of the control circuit 104 constitute a time period measurement unit. Further, the system reset circuit 112 constitutes a reset unit.

In addition, as discussed above, the chronograph timepiece according to this embodiment is such a type of chronograph timepiece that the chronograph hands are mechanically reset to zero in response to a reset directed by the reset button RB and the chronograph hands are electrically driven in response to a start directed by the start/stop button STB. The detailed explanation of the mechanical devices thereof is omitted because these devices are publicly known.

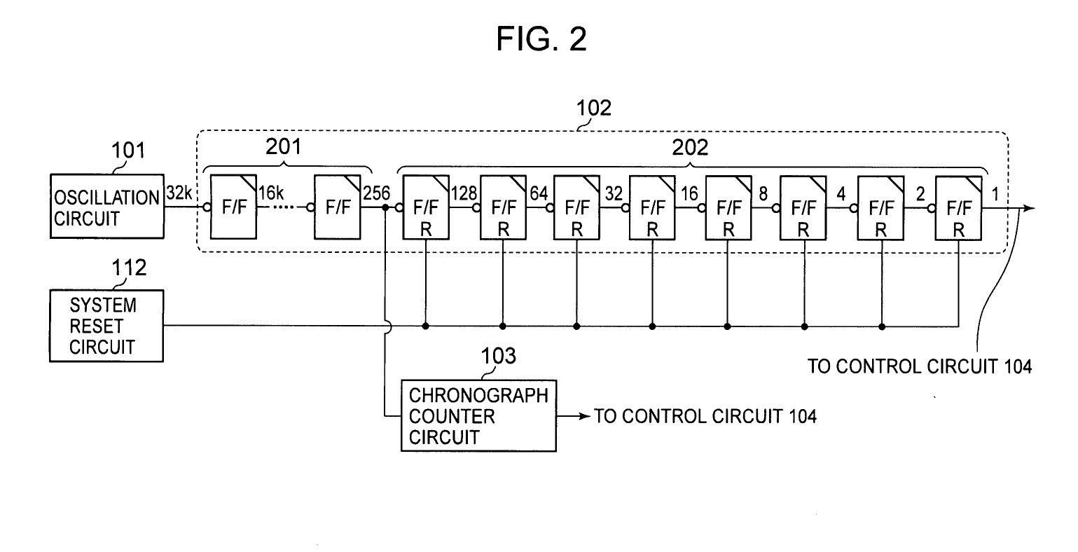

FIG. 2 is a detailed circuit diagram depicting the divider circuit 102 for use in this embodiment. The same components as those in FIG. 1 are designated the same numerals and signs.

In FIG. 2, the divider circuit 102 is a divider circuit having a publicly-known configuration, in which a plurality of flip-flops (F/F) are connected in multiple stages and the flip-flops individually form a single dividing stage. The divider circuit 102 includes a first dividing stage section 201 having a plurality of dividing stages for generating a chronograph signal, and a second dividing stage section 202 having a plurality of dividing stages for generating a clock signal at a frequency lower than that of the chronograph signal, in which these sections 201 and 202 are in cascade connection. The first dividing stage section 201 is a dividing stage section that generates a signal at a frequency higher than that which the second dividing stage section 202 generates. Each reset terminal R of the individual flip-flops in the second dividing stage section 202 is connected with the system reset circuit 112 such that a reset signal is fed to the reset terminal R from the system reset circuit 112 to reset the second dividing stage section 202.

A 32-kHz signal generated by the oscillation circuit 101 is sequentially divided into a half of the frequency by the individual flip-flops. A 256-Hz chronograph signal is outputted from the final stage of the first dividing stage section 201 to the chronograph counter circuit 103. A 1-Hz clock signal is outputted from the final stage of the second dividing stage section 202, which is the final stage of the divider circuit 102, to the control circuit 104.

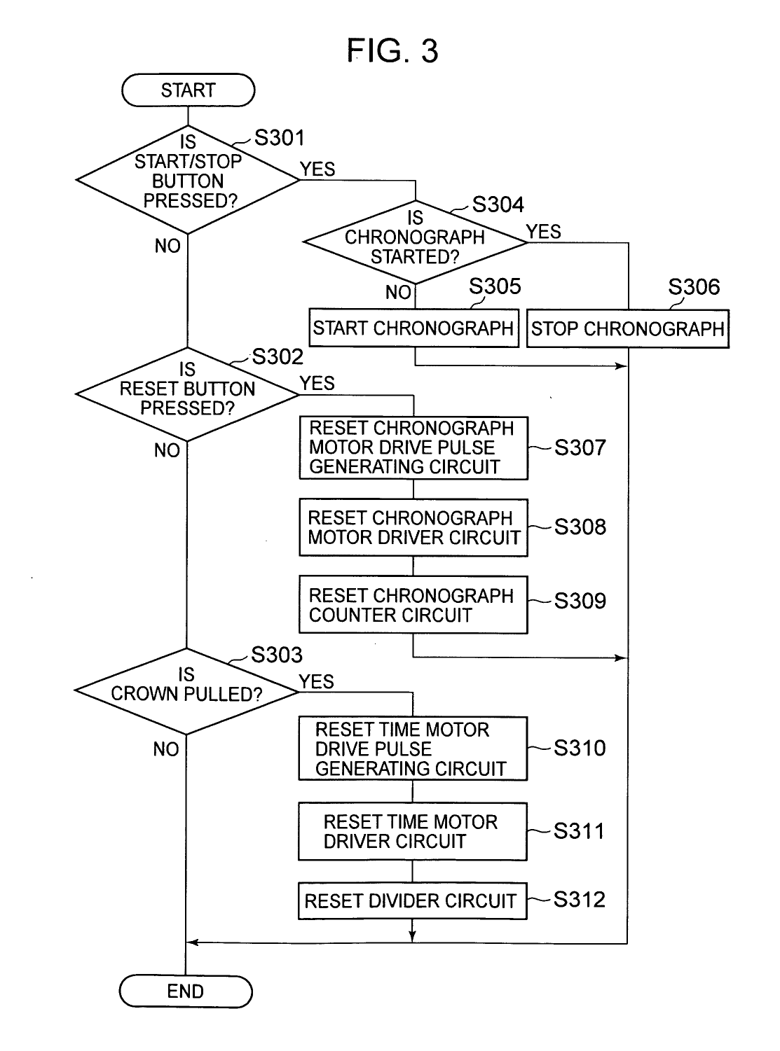

FIG. 3 is a flow chart depicting the chronograph timepiece according to the embodiment of the invention, which is a flow chart mainly depicting the process of the control circuit 104.

In the following, the operation of the chronograph timepiece according to this embodiment will be described with reference to FIGS. 1 to 3.

In FIG. 1, the oscillation circuit 101 generates a signal at a predetermined frequency. The divider circuit 102 divides the signal generated at the oscillation circuit 101 and outputs a clock signal to be reference for timing from the second dividing stage section 202 to the control circuit 104 as well as outputs a chronograph signal to be reference for measuring a time period from the first dividing stage section 201 to the chronograph counter circuit 103.

The control circuit 104 controls the time motor drive pulse generating circuit 105 so as to move and drive the time hands of the analog indicating unit 111 by counting the clock signal for a timing operation using the timing counter to output a time control signal. The time motor drive pulse generating circuit 105 rotates and drives the time motor 107 through the time motor driver circuit 106 in response to the time control signal, and the time motor 107 moves and drives the time hands of the analog indicating unit 111 to indicate the current time of day at any time.

In the case of starting a time period measurement operation of the chronograph timepiece, the start/stop button STB is operated to start the operation when the time period measurement operation is stopped.

When the control circuit 104 determines that the start/stop button STB has been operated (Step S301), it starts a time period measurement operation (start chronograph) (Step S305), as the state of the chronograph timepiece at that time is not in the time period measurement state (chronograph start state) (Step S304). In this case, the control circuit 104 performs control in such a way that after the mechanical devices, not shown, clear the set chronograph hands in response to the start directed by the start/stop button STB, the chronograph counter circuit 103 starts the time period measurement operation based on the chronograph signal from the divider circuit 102 in response to the start.

When the state of the chronograph timepiece at that time is in the time period measurement state in process step S304, the control circuit 104 stops the time period measurement operation (stop chronograph) (Step S306). When the start/stop button STB is operated to stop the time period measurement operation during the time period measurement operation, the control circuit 104 stops the time period measurement operation in response to this stop, and a time period measurement result at that point in time is indicated on the analog indicating unit 111.

As described above, the control circuit 104 performs control to switch between the start and stop of the time period measurement operation every time when the start/stop button STB is operated.

When the control circuit 104 determines that the start/stop button STB is not operated in process step S301 and then determines that the reset button RB has been operated (Step S302), it resets the time period measurement counter as well as the system reset circuit 112 resets the chronograph motor drive pulse generating circuit 108 and the chronograph motor driver circuit 109 (Steps S307 and S308) and resets the chronograph counter circuit 103 (Step S309). Consequently, the circuits (chronograph hand drive unit) for measuring a time period to drive the chronograph hands are reset whereas the circuits (time hand drive unit) for keeping time of day to drive the time hands are not reset. Accordingly, the timing operation can be continuously operated.

As described above, when the chronograph hand drive unit is brought into the partial system reset state for replacing a battery, or the like, this can be performed by operating the reset button RB for resetting the time period measurement operation. For this reason, it is made possible that even though something abnormal happens during the time period measurement operation, components are readily returned to normal operations since the partial system reset can be performed by means of an easy-to-understand operation for users.

Additionally, when a user operates the reset button RB to direct a reset during the time period measurement operation, the control circuit 104 resets the chronograph hand drive unit in response to this reset, and then the mechanical devices reset the chronograph hands to zero in response to the reset directed by the reset button RB.

When the control circuit 104 determines that the reset button RB is not operated in process step S302 and then determines that the crown RZ has been operated to be reset (in the embodiment, the crown is pulled) (Step S303), the system reset circuit 112 resets the time motor drive pulse generating circuit 105 and the time motor driver circuit 106 (Steps S310 and S311) and resets the second dividing stage section 202 in the divider circuit 102 (Step S312). Consequently, the circuits (time hand drive unit) for keeping time of day and driving the time hands are reset.

However, because only the second dividing stage section 202 is rest at this time and the first dividing stage section 201 is not reset, the timing operation is reset but the time period measurement operation is not reset. Accordingly, the time period measurement operation can be continuously performed since the chronograph hand drive unit is not reset. As described above, when the time hand drive unit is brought into the partial system reset for replacing a battery, or the like, this can be performed by operating the crown for setting time of day or the like. Accordingly, it is made possible that the time hand drive unit is readily returned to normal operations since the partial system reset can be performed by means of an easy-to-understand operation for users.

When the control circuit 104 determines that the crown RZ is not operated for a reset in process step S303, it ends the process.

When the system reset for the entire chronograph timepiece is performed, a predetermined signal is fed to the system reset terminal SR. For example, the system reset terminal SR is set at a predetermined potential (for instance, power supply voltage). The control circuit 104 performs a system reset for the entire electric circuits configuring the chronograph timepiece by detecting that a predetermined signal has been fed to the system reset terminal SR.

As described above, according to the chronograph timepiece of this embodiment, for such a type of chronograph timepiece that chronograph hands are mechanically reset to zero and electrically driven, the control unit is provided for resetting the time hand drive unit in response to a reset directed by the crown as wells for resetting the chronograph hand drive unit in response to a reset directed by the operating unit.

Accordingly, because electrical resets can be performed by means of typical operations for chronograph timepieces, it is made possible that components are returned to normal operations since the system reset can be performed by means of an easy-to-understand operation for users. Also, it is made possible to perform the partial system reset for electrical components configuring the chronograph timepiece and the system reset for all the components.

In addition, in the embodiment, the clock signal and the chronograph signal are used, which are at different frequencies. However, these signals may be the same signal depending on the specifications of chronograph timepieces.

This invention is applicable to various chronograph timepieces that motors electrically drive time hands and chronograph hands and mechanical devices set the chronograph hands in the reset state so as not to move the chronograph hands, and the chronograph hands are driven after the setting by the mechanical devices is cleared.

What is claimed is:

1. A chronograph timepiece comprising:
a signal generating unit configured to output a clock signal to be reference for timing and a chronograph signal to be reference for measuring a time period;
a crown;
an operating unit configured at least to start and reset a time period measurement operation;
a time hand drive unit configured to keep time of day based on the clock signal to electrically drive a time hand so as to indicate a timed time of day; and
a chronograph hand drive unit configured to perform the time period measurement operation based on the chronograph signal in response to the start directed by the operating unit to electrically drive a chronograph hand so as to indicate a measured time period and for resetting the time period measurement operation in response to the reset directed by the operating unit, the chronograph hand being mechanically reset to zero in response to the reset directed by the operating unit, wherein
a control unit is provided for resetting the time hand drive unit in response to a reset directed by the crown and resetting the chronograph hand drive unit in response to the reset directed by the operating unit.

2. A chronograph timepiece according to claim 1, wherein
the signal generating unit includes:
an oscillation circuit for generating a signal at a predetermined frequency; and
a divider circuit having a first dividing stage section for dividing the signal from the oscillation circuit to output the chronograph signal and a second dividing stage section for dividing the signal from the oscillation circuit to output the clock signal, wherein
the control unit resets the time hand drive unit in response to the reset directed by the crown and resets the second dividing stage section.

3. A chronograph timepiece according to claim 2, wherein
the first dividing stage section and the second dividing stage section are in cascade connection, and
the first dividing stage section outputs a signal at a frequency higher than that which the second dividing stage section does.

4. A chronograph timepiece according to claim 1, further comprising a system reset terminal for performing a system reset for the entire chronograph timepiece, wherein
the control unit performs the system reset when a predetermined signal is fed to the system reset terminal.

5. A chronograph timepiece according to claim 2, further comprising a system reset terminal for performing a system reset for the entire chronograph timepiece, wherein
the control unit performs the system reset when a predetermined signal is fed to the system reset terminal.

6. A chronograph timepiece according to claim 3, further comprising a system reset terminal for performing a system reset for the entire chronograph timepiece, wherein
the control unit performs the system reset when a predetermined signal is fed to the system reset terminal.
